(19) United States
(12) Patent Application Publication
(10) Pub. No.: US 2022/0036337 A1
(43) Pub. Date: Feb. 3, 2022

(54) AUDIO-BASED EXIT DETECTION AND PAYMENT CONFIRMATION FOR COMPUTING DEVICES

(71) Applicant: LISNR, Cincinnati, OH (US)

(72) Inventors: Craig Kawahara, San Mateo, CA (US); Srivathsan Narasimhan, Saratoga, CA (US); Eric Allen, Sammamish, WA (US)

(21) Appl. No.: 17/387,568

(22) Filed: Jul. 28, 2021

Related U.S. Application Data
(60) Provisional application No. 63/058,913, filed on Jul. 30, 2020.

(51) Int. Cl. G06Q 20/32; G08B 21/18; H04B 11/00; G06Q 20/38; G07C 9/10; G07C 9/38; G06Q 40/00

(52) U.S. Cl. CPC G06Q 20/3272; G08B 21/18; H04B 11/00; G06Q 40/12; G07C 9/10; G07C 9/38; G06Q 20/388

(57) ABSTRACT

Methods and systems for improved exit detection, payment confirmation, and payment authorization verification are provided. In one embodiment, a method is provided that includes transmitting an audio transmission that includes a unique identifier of a facility. The audio transmission may be transmitted to a computing device, which may transmit in response an audio transmission containing a unique identifier and a payment confirmation identifier. The payment confirmation identifier may be compared to a database of payment information and it may be determined that the payment confirmation identifier corresponds to a completed payment. It may further be determined that the user has completed a payment and is permitted to exit the facility.

### CROSS-REFERENCE TO RELATED APPLICATIONS

The present application claims priority to U.S. Provisional Patent Application No. 63/058,913, filed on Jul. 30, 2020, the disclosure of which is incorporated herein by reference for all purposes.

### BACKGROUND

Facilities may include equipment for monitoring when individuals enter or leave the facilities. For example, equipment may be located at entrances or exits to the facilities to detect when individuals enter or leave the facility. As another example, equipment may monitor the locations of individuals within the facility.

### SUMMARY

The present disclosure presents new and innovative systems and methods for improved exit detection, payment confirmation, and payment authorization verification are provided. In one general aspect, a method is provided that includes transmitting, to a first computing device, an audio transmission with a first unique identifier of a facility. The method may also include receiving, from the first computing device, an audio transmission containing a first identifier of a user associated with the first computing device and a payment confirmation identifier. The method may also include comparing the payment confirmation identifier to a database of payment information. The method may also include determining that the payment confirmation identifier corresponds to at least one completed payment within the database of payment information. The method may also include determining that the user has completed a payment and is permitted to exit the facility. Other embodiments of this aspect may include corresponding computer systems, apparatuses, and computer programs recorded on one or more computer storage devices (e.g., computer-readable media), each configured to perform the actions of the method.

Certain aspects may include one or more of the following features. The method where the first unique identifier is transmitted by a transmitter located near an exit of the facility. The method further including (i) transmitting, to the first computing device, audio transmissions containing a second unique identifier of the facility. The method further including (ii) receiving, from the first computing device an audio transmission containing a second identifier of the user. The method further including repeating (i) and (ii) until the second identifier is not received from the first computing device at (ii) and, in response to determining that the second identifier is not received, processing payment for a purchase associated with the user associated with the first computing device. The method further including comparing the first identifier to the second identifier to identify the user. The method where the second unique identifier of the facility is identical to the first unique identifier of the facility. The method where the second unique identifier differs at least in part from the first unique identifier of the facility. The method where the first identifier of the user is a persistent identifier of the user. The method further including at least one of (i) illuminating a light over the user, (ii) changing the color of a light over the user, (iii) updating a first visual indicator located near an exit of the facility, (iv) removing a physical obstruction of the exit, (v) displaying a second visual indicator on the first computing device, and (vi) displaying a third visual indicator on a second computing device associated with the facility. The method where the first computing device at least temporarily lacks an internet connection. The method where the facility is a store. The method where the database of payment information is located on a third computing device connected to a local network of the facility. Implementations of the described techniques may include hardware, a method or process, or computer software stored on a computer-readable medium.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system according to an exemplary embodiment of the present disclosure.

FIG. 2 illustrates an audio transmission according to an exemplary embodiment of the present disclosure.

FIGS. 3A-3B illustrate a transmitter/receiver array according to an exemplary embodiment of the present disclosure.

FIG. 4 illustrates an audio channel distribution according to an exemplary embodiment of the present disclosure.

FIGS. 5A-5B illustrate audio transmission scenarios according to exemplary embodiments of the present disclosure.

FIG. 6 illustrates a system for transmitting and processing audio transmissions intended for merchant platforms according to an exemplary embodiment of the present disclosure.

FIG. 7 illustrates a system for detecting user locations within a facility according to an exemplary embodiment of the present disclosure.

FIGS. 8A-8B illustrate payment confirmation scenarios according to exemplary embodiments of the present disclosure.

FIG. 9 illustrates a method for exit detection and payment confirmation according to an exemplary embodiment of the present disclosure.

FIG. 10 illustrates a method for exit detection and payment processing according to an exemplary embodiment of the present disclosure.

FIG. 11 illustrates a computing system according to an exemplary embodiment of the present disclosure.

### DETAILED DESCRIPTION OF EXAMPLE EMBODIMENTS

Aspects of the present disclosure relate to transmitting and receiving audio transmissions between multiple devices. In certain aspects, a computing device may be associated with a facility and may transmit and/or receive audio transmissions from one or more computing devices located nearby to verify whether users associated with the one or more computing devices are located within the facility or have exited the facility.

Various techniques and systems exist to exchange data between computing devices located near one another without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi® links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

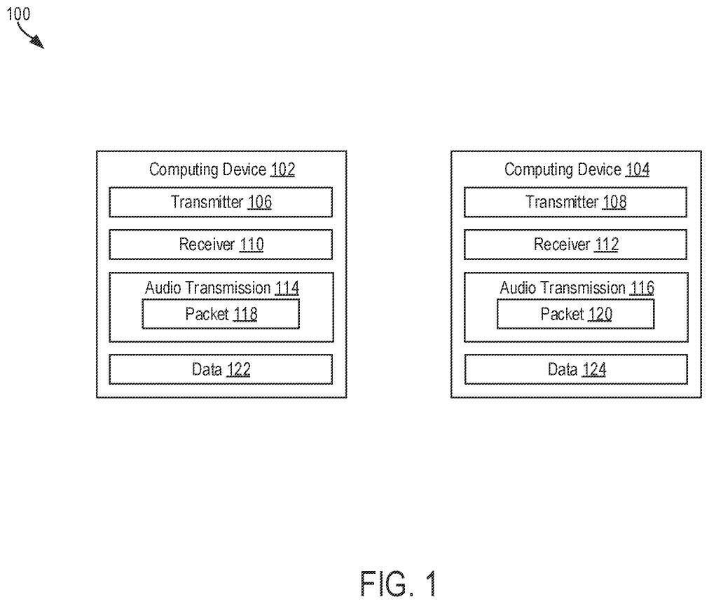

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers or transducers. In certain implementations, the transmitters 106, 108 may be implemented as a speaker built into the computing device 102, 104. For example, one or both of the computing devices may be a smartphone, tablet computer, and/or laptop with a built-in speaker that performs the functions of the transmitter 106, 108. In other implementations, the transmitters 106, 108 may be implemented as a speaker or transducer external to the computing device 102, 104. For example, the transmitters 106, 108 may be implemented as one or more speakers or transducers externally connected to the computing device 102, 104. In still further implementations, transmitters 106, 108 may be communicatively separate from computing devices.

The receivers 110, 112 may include any type of device capable of receiving audio transmissions and converting the audio transmissions into signals (e.g., analog signals, digital signals) capable of being processed by a processor of the computing device, such as microphones. In other implementations, the receivers 110, 112 may be implemented as a microphone built into the computing device 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing at least one speaker and at least one microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

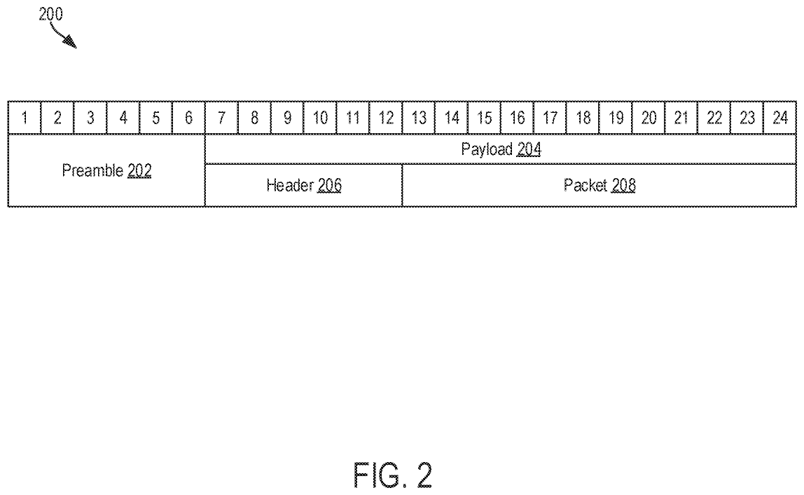

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other durations of the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined symbols produced at predetermined points of time (e.g., by varying one or more of the frequency and the phase in a predetermined manner for the frequencies 1-6). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200 (or another predetermined portion of the audio transmission 200), the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

The techniques described above may be used to improve the identification of users located within a facility and/or the detection of when particular users leave a facility. Existing systems used to determine when users enter or leave a facility may require the users to manually present an identifier, such as an identifier that uses wireless communication (e.g., RFID, BLE) to identify a user or a visual identifier (e.g., images of the user, QR codes) of the user. These systems, however, can be tedious and inaccurate. In particular, requiring users to present an identifier each time they enter or leave a facility can increase the time required for the users to enter or leave. Accordingly, in facilities with high throughput (e.g., stores and other retail facilities), bottlenecks or other delays may form at entrances and exits as users wait to present their identifiers. Furthermore, it may be possible for users to deliberately or accidentally bypass equipment used to scan the identifiers. For example, users may walk past turnstiles at entrances or exits equipped to scan identifiers. As another example, where identifiers are used to unlock doors at entrances or exits, one user may scan their identifier and hold the door open for a second user such that the second user is not required to present their identifier. In either of these examples, one or more users may enter or exit the facility undetected. Therefore, there exists a need to automatically identify when users enter or leave a facility without requiring the users to manually present identifiers. Furthermore, to reduce the need for specialized hardware by the users, entering and exiting users should be identified without requiring specialized wireless communication protocols.

One solution to this problem is to identify when users enter or exit a facility using audio transmissions. For example, computing devices associated with users may receive audio transmissions from computing devices associated with the facility. For example, the computing devices associated with the facility may be located near entrances and/or exits of the facility. Upon receiving audio transmissions from computing devices associated with the facility, the computing devices associated with the user may determine that the user is still located within the facility. In certain instances, the computing devices associated with the user may transmit additional audio transmissions that contain identifiers of the users. The computing devices may receive the additional audio transmissions and may determine, based on the identifiers of the users, which users have entered or exited the facility or are still located within the facility. In certain instances, audio transmissions may be used to confirm payment by the users before exiting the facility (e.g., where the facility is a store). For example, upon approaching an exit of the facility, a computing device associated with the facility may transmit an audio transmission. In response, a computing device associated with a user may respond with an audio transmission that includes a payment confirmation identifier. The computing device associated with the facility may confirm the payment confirmation identifier and, in response, may determine that the user is permitted to exit the facility.

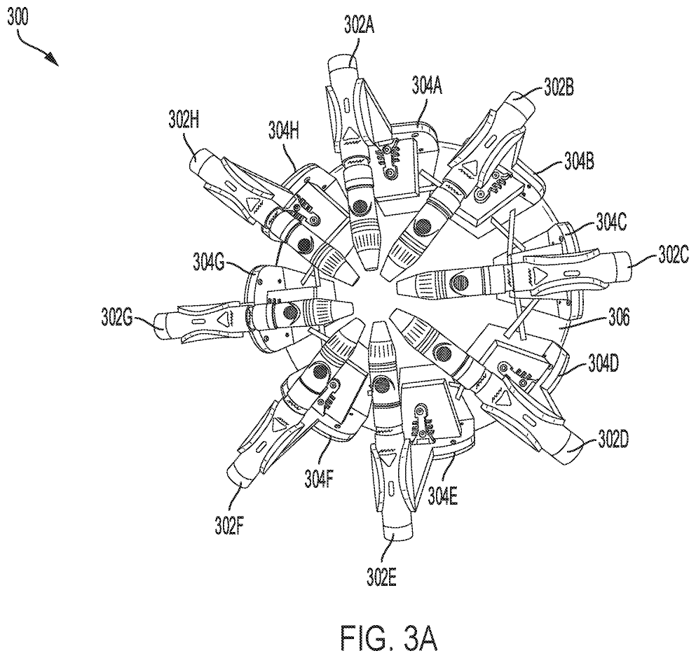

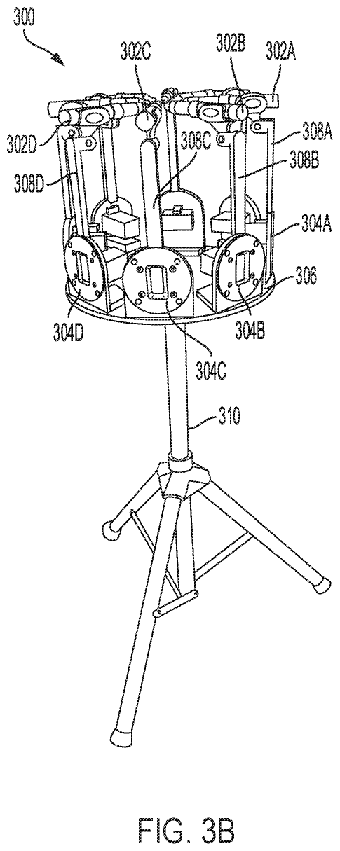

FIGS. 3A-3B illustrate a transmitter/receiver array 300 according to an exemplary embodiment of the present disclosure. The transmitter/receiver array 300 may be used to transmit and/or receive audio transmissions 114, 116, 200. For example, the transmitter/receiver array 300 may be an exemplary implementation of at least one of the computing devices 102, 104. The transmitter/receiver array 300 includes eight receivers 302A-H and eight transmitters 304 A-H. Each of the eight receivers 302A-H may be exemplary implementations of the receivers 110, 112. For example, the eight receivers 302A-H may be implemented as microphones. Each of the eight transmitters 304A-H may be exemplary implementations of the transmitters 106, 108. For example, the eight transmitters 304A-H may be implemented as speakers.

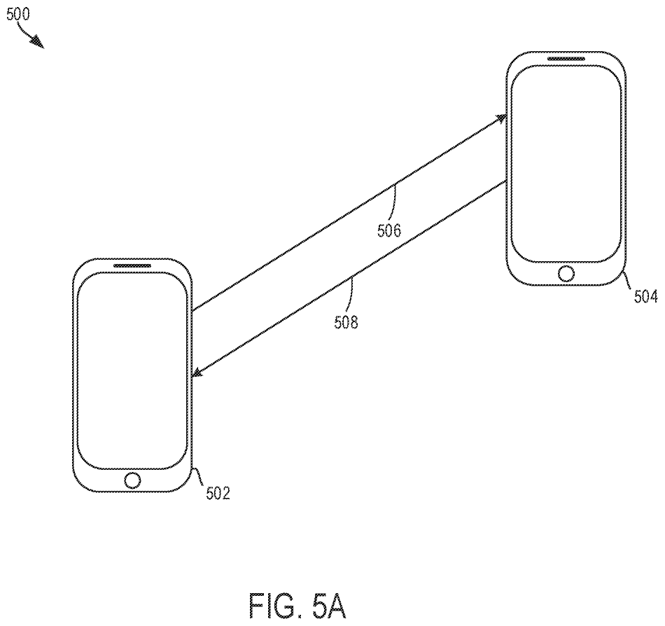

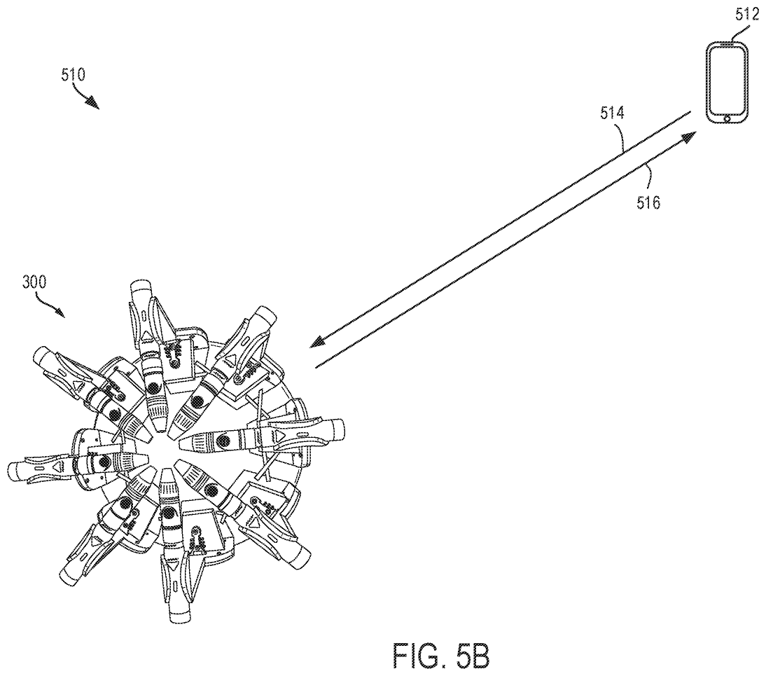

As depicted, the receivers 302A-H and the transmitters 304A-H are arranged to evenly cover a 360° area surrounding the transmitter/receiver array 300. For example, the receivers 302A-H and transmitters 304A-H are arranged so that there is approximately 45° between adjacent receivers 302A-H and adjacent transmitters 304A-H. Such a configuration may enable the transmitter/receiver array 300 to receive audio transmissions 114, 116, 200 from and transmit audio transmissions 114, 116, 200 in multiple directions within a coverage area of the transmitter/receiver array 300. The transmitter/receiver array 300 may be configured to receive and transmit audio transmissions 114, 116, 200 from computing devices located within the coverage area of the transmitter/receiver array 300. For example, FIG. 5B illustrates a scenario 510 in which a computing device 512 (e.g., a mobile device) transmits audio transmissions 514 to the transmitter/receiver array 300 and receives audio transmissions 516 from the transmitter/receiver array 300.

Returning to FIGS. 3A-3B, the receivers 302A-H and the transmitters 304A-H may be mounted on a support body 306. The support body 306 may allow the transmitter/receiver array 300 to be positioned and configured without altering the relative orientation of the receivers 302A-H and the transmitters 304A-H. In certain implementations, the receivers 302A-H may be mounted such that the receivers 302A-H are separated from the transmitters 304A-H (e.g., so that the receivers 302A-H can avoid interference from the transmitters 304A-H). For example, the receivers 302A-H may be mounted on structural members 308A-D (only a subset of which are depicted in FIG. 3B) that separate the receivers 302A-H from the transmitters 304A-H. In certain implementations, the transmitter/receiver array 300 may be mounted on a support element, such as the support element 310. The support element 310 may raise the transmitter/receiver array 300 from the ground such that the transmitter/receiver array 300 is at a height better suited to receiving and transmitting audio transmission 200 (e.g., at or between chest and waist height for a typical individual). Additionally or alternatively, the transmitter/receiver array 300 may be mounted on a table, counter, or ceiling (e.g., in a retail establishment).

It should be appreciated that additional or alternative implementations of the transmitter/receiver array 300 are possible. For example, alternative implementations may have more or fewer transmitters and/or receivers and/or may have larger or smaller transmitters and/or receivers. As another example, alternative implementations may omit one or more of the support body 306, the structural members 308A-D, and/or the support elements 310. As yet another example, alternative implementations may further include a housing surrounding the transmitters 304A-H and/or receivers 302A-H.

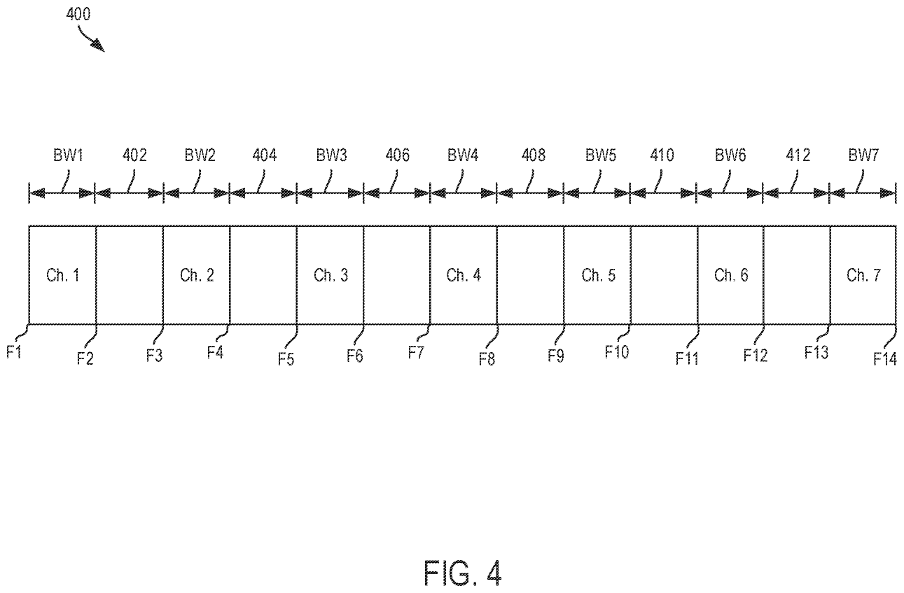

FIG. 4 illustrates an audio channel distribution 400 according to an exemplary embodiment of the present disclosure. The audio channel distribution 400 includes audio channels 1-7 distributed along a frequency spectrum F1-F15. Each audio channel 1-7 has a corresponding bandwidth BW1-7. In particular, audio channel 1 has a bandwidth BW1 spanning from F1 to F2, audio channel 2 has a bandwidth BW2 spanning from F3 to F4, audio channel 3 has a bandwidth BW3 spanning from F5 to F6, audio channel 4 has a bandwidth BW4 spanning from F7 to F8, audio channel 4 has a bandwidth BW5 spanning from F9 to F10, audio channel 6 has a bandwidth BW6 spanning from F11 to F12, and audio channel 7 has a bandwidth BW7 spanning from F13 to F14. The audio channels 1-7 may represent a range of carrier frequencies that can be used to transmit audio transmissions. For example, to transmit an audio transmission according to an audio channel 1, a computing device may utilize a carrier frequency between F1 and F2. In certain implementations, the computing device may use a carrier frequency halfway between F1 and F2. As a specific example, where F1 is 9.5 kHz and F2 is 10.5 kHz, a computing device transmitting an audio transmission using audio channel 1 may preferably utilize a carrier frequency between 9.8 and 10.2 kHz, such as 10 kHz.

The audio channels 1-7 are also separated by frequency bands 402, 404, 406, 408, 410, 412. In particular, frequency band 402 separates audio channels 1 and 2 and spans from frequency F2 to F3, frequency band 404 separates audio channels 2 and 3 and spans from frequency F4 to F5, frequency band 406 separates audio channels 3 and 4 and spans from frequency F6 to F7, frequency band 408 separates audio channels 4 and 5 and spans from frequency F8 to F9, frequency band 410 separates audio channels 5 and 6 and spans from frequency F10 to F11, and frequency band 412 separates audio channels 6 and 7 and spans from frequency F12 to F13. The frequency bands 402, 404, 406, 408, 410, 412 may separate the audio channels 1-7, which may help prevent audio transmissions from interfering with one another.

In certain implementations, the audio channels 1-7 may have equal bandwidths BW1-7. For example, each of the bandwidths BW1-7 may be 1 kHz wide, although other implementations may also be used (e.g., bandwidths of 500 Hz, 2 kHz, 5 kHz). In additional or alternative implementations, the audio channels 1-7 may have different bandwidth BW1-7. Additionally, in certain implementations, the frequency bands 402, 404, 406, 408, 410, 412 may be of equal width. For example, each of the frequency bands 402, 404, 406, 408, 410, 412 may be 1 kHz wide, although other implementations may also be used (e.g., frequency bands of 500 Hz, 2 kHz, 5 kHz). In further implementations, the frequency bands 402, 404, 406, 408, 410, 412 may have different widths.

In certain implementations, the bandwidths BW1-7 and frequency bands 402, 404, 406, 408, 410, 412 may have the same width. For example, the bandwidths BW1-7 and frequency bands 402, 404, 406, 408, 412 may all have a width of 1 kHz. In such instances, frequency F1 may be 9.5 kHz, frequency F2 may be 10.5 kHz, frequency F3 may be 11.5 kHz, frequency F4 may be 12.5 kHz, frequency F5 may be 13.5 kHz, frequency F6 may be 14.5 kHz, frequency F7 may be 15.5 kHz, frequency F8 may be 16.5 kHz, frequency F9 may be 17.5 kHz, frequency F10 may be 18.5 kHz, frequency F11 may be 19.5 kHz, frequency F12 may be 20.5 kHz, frequency F13 may be 21.5 kHz, and frequency F14 may be 22.5 kHz.

It should also be understood that alternative embodiments of the audio channel distribution 400 may use additional or fewer channels. For example, alternative implementations may include 10 audio channels. As another example, alternative implementations may include five or six audio channels.

FIG. 5A illustrates an audio transmission scenario 500 according to exemplary embodiments of the present disclosure. In the scenario 500, a computing device 502 transmits an audio transmission 506 to the computing device 504. The computing device 504 also transmits an audio transmission 508 to the computing device 502. As depicted, both of the computing devices 502, 504 are mobile devices (e.g., smartphones). Accordingly, the audio transmissions 506, 508 may be transmitted using speakers of the mobile devices and may be received using microphones of the mobile devices. In certain implementations, the audio transmissions 506, 508 may be transmitted at different times. For example, the computing device 502 may transmit the audio transmission 506 before the computing device 504 transmits the audio transmission 508. In other implementations, the audio transmissions 506, 508 may be transmitted at least partially at the same time. In such instances, the audio transmissions 506, 508 may be transmitted on different channels (e.g., using different carrier frequencies), as explained further below.

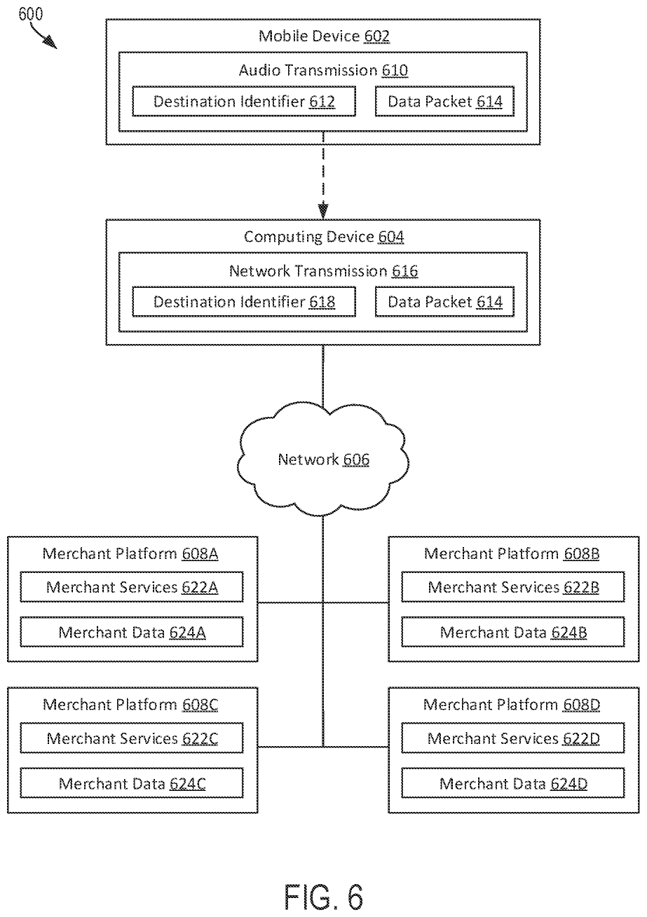

FIG. 6 illustrates a system 600 for transmitting and processing audio transmissions intended for merchant platforms according to an exemplary embodiment of the present disclosure. The system 600 may be configured to receive and process audio transmissions containing data for use by merchant platforms. For example, the system 600 includes a mobile device 602, a computing device 604, and merchant platforms 608A-D. The system 600 may be configured to receive audio transmissions 610 and to direct or otherwise process the audio transmissions 610 for use by the merchant platforms 608A-D.

The merchant platforms 608A-D may be configured to provide merchant services 622A-D and/or to store merchant data 624A-D. For example, the merchant services 622A-D may include payment services, product selection and/or ordering services, inventory services, product assistance services, shopping assistance services, store or facility navigation services, customer relationship management (CRM) services, enterprise resource planning (ERP) services, and the like. The merchant platforms 608A-D may be associated with different merchant entities. For example, the merchant platform 608A may be associated with a payment processor, the merchant platform 608B may be associated with a retail company operating one or more retail stores, and the merchant platform 608C may be associated with a particular retail store operated by the retail company. Merchant platforms 608A-D associated with different merchant entities may provide different merchant services 622A-D. Continuing the previous example, the merchant platform 608A may provide payment services; the merchant platform 608B may provide product information, inventory, and product ordering services; and the merchant platform 608C may provide navigation assistance services (e.g., a map of the particular retail store) and shopping assistance services (e.g., requesting help from an employee of the particular retail store). The merchant platforms 608A-D may also store merchant data 624A-D. The merchant data 624A-D may differ depending on the merchant services 622A-D offered by the merchant platforms 608A-D. For example, the merchant data 624A stored by the merchant platform 608A includes payment data for payments processed by the payment provider; the merchant data 624B stored by the merchant platform 608B may include inventory data, order data, and/or product information data; and the merchant data 624C stored by the merchant platform 608C may include data reflecting a map of the facility, and/or data regarding shopping assistance requests and employees who provided shopping assistance.

To request or utilize the merchant services 622A-D offered by the merchant platforms 608A-D, the mobile device 602 may transmit audio transmissions 610. For example, an application executing on the mobile device 602 may present one or more service options to a user of the mobile device 602. Upon selecting or utilizing one or more of the service options, the mobile device 602 may generate a corresponding audio transmission 610. The audio transmission 610 includes a destination identifier 612 and a data packet 614. As discussed above, the destination identifier 612 and the data packet 614 may be stored in a payload 204 of the audio transmission 610. For example, the destination identifier 612 may be stored as the header 206 of the audio transmission 610 and the data packet 614 may be stored as the packet 208 of the audio transmission 610. The destination identifier 612 may include an identifier of a particular merchant platform 608A-D and/or a particular merchant service 622A-D that is requested (e.g., that the user selected via the application). For example, the merchant platforms 608A-D and/or the merchant services 622A-D may be associated with unique identifiers. The mobile device 602 may store one or more of these unique identifiers for use in generating the audio transmissions 610. In particular, the destination identifier 612 may include the unique identifier associated with the requested merchant platform 608A-D or merchant services 622A-D. The data packet 614 may store data required to perform the requested merchant service 622A-D. For example, where the user requests payment services, the data packet 614 may contain payment data. As another example, where the user requests product ordering services, the data packet 614 may include a product identifier. As a further example, where the user requests store navigation services, the data packet 614 may include an identifier of the user.

The mobile device 602 may then transmit the audio transmission 610 to the computing device 604. In particular, the audio transmission 610 may be received by a microphone or other receiver communicatively coupled to the computing device 604. The computing device 604 may then generate a network transmission 616 based on the received audio transmission 610. In particular, the network transmission 616 may contain the same data packet 614 as the audio transmission 610. The network transmission 616 may also include destination identifier 618. The destination identifier 618 may be generated as a network address or other identifier of the particular merchant platform 608A-D and/or a particular merchant service 622A-D identified by the destination identifier 612. For example, the computing device 604 may store a mapping between the unique identifiers of merchant platforms 608A-D and merchant services 622A-D and the associated network addresses or endpoints for the merchant platforms 608A-D and merchant services 622A-D. For example, the computing device 604 may store universal resource locators (URLs) or other addresses corresponding to the merchant platforms 608A-D (e.g., to application programming interfaces (APIs) offered by the merchant platforms 608A-D). The computing device 604 may also store endpoints, API calls, or other internal identifiers of the merchant services 622A-D within the merchant platform 608A-D. Where the destination identifier 612 corresponds to a merchant platform 608A-D, the computing device 604 may generate the destination identifier 618 to include the address of the API for the corresponding merchant platform 608A-D. Where the destination identifier 612 corresponds to a particular merchant service 622A-D, the computing device 604 may generate the destination identifier 618 to include both the address of the API for the merchant platform 608A-D implementing the particular merchant service 622A-D and the endpoint or internal identifier for the particular merchant service 622A-D.

The computing device 604 and the merchant platforms 608A-D are connected to the network 606. After generating the network transmission 616, the computing device 604 may transmit the network transmission 616 to the corresponding merchant platform 608A-D. For example, the destination identifier 618 may be generated as described above to include routing information to the corresponding merchant platform 608A-D via the network 606. The network 606 may be implemented as a local network and/or as a global network (e.g., the Internet). The computing device 604 and the merchant platforms 608A-D may connect to the network 606 via one or more wired (e.g., Ethernet) and/or wireless (e.g., Wi-Fi) network interfaces. Notably, the mobile device 602 is not required to be connected to the network 606. Therefore, if the mobile device 602 lacks network connectivity and cannot connect to the Internet and/or if the network 606 is a private network that the mobile device 602 cannot access, the mobile device 602 is still able to communicate with merchant platforms via the computing device 604 without having to connect to the network 606 or otherwise communicatively pair with the computing device 604.

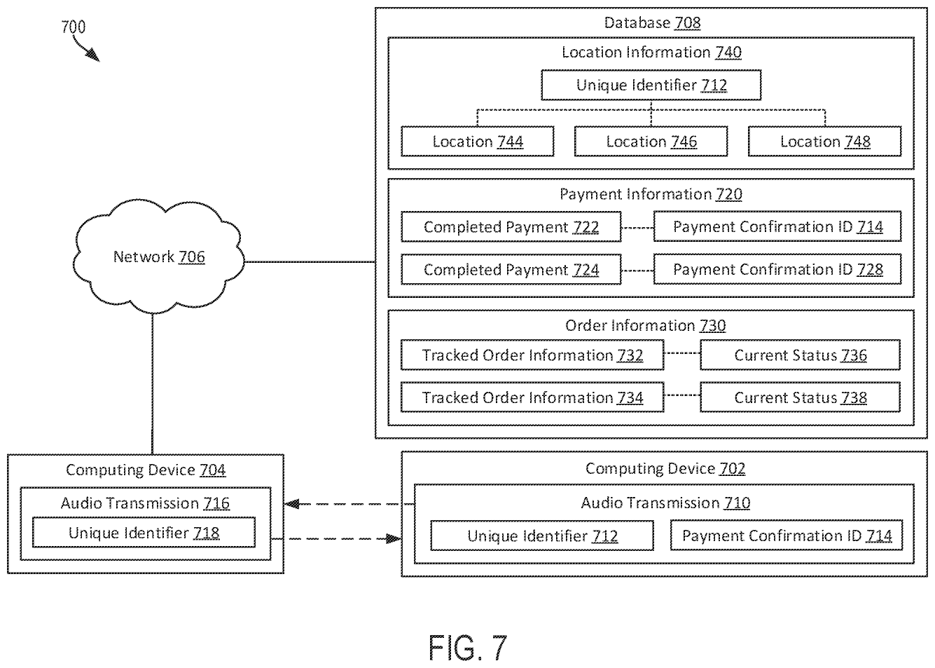

FIG. 7 illustrates a system 700 for detecting user locations within a facility according to an exemplary embodiment of the present disclosure. The system 700 includes computing devices 702, 704 and a database 708. In certain implementations, the computing device 702 may be associated with a user of the facility. For example, the computing device 702 may be associated with a customer or employee of the facility. In certain implementations, the computing device 702 may be a mobile device (e.g., smartphone, tablet computer) associated with the user (e.g., owned by the user, assigned to the user while working). In additional or alternative implementations, the computing device may be a wearable computing device (e.g., a smartwatch or a clip-mounted computing device that attaches to the user's clothing, belt, shoes, hands, etc.) associated with the user (e.g., owned by the user, assigned to the user while working).

The computing device 704 may be associated with the facility. For example, the computing device 704 may be mounted or positioned at an entrance or exit of the facility to monitor when users enter or exit the facility. Additionally or alternatively, the computing device 704 may be positioned within the facility to determine a user location within the facility (e.g., based on a proximity to the computing device 704). In practice, the facility may include multiple computing devices in addition to the computing device 704. For example, the facility may include computing devices positioned near each of, or a subset of, the entrances and exits to the facility. Additionally or alternatively, multiple computing devices may be positioned throughout the facility (e.g., an interior of the facility). At least a subset of the computing devices may be implemented at least in part using transmitter-receiver arrays, such as the transmitter-receiver array 300. In certain implementations, multiple transit-receiver arrays positioned throughout the facility and/or at multiple entrances or exits of the facility may be connected to a single computing device to receive and process audio transmissions.

The computing devices 702, 704 may be configured to communicate using audio transmissions 710, 716 using techniques similar to those discussed above with the system 600. For example, the computing device 702 may receive the audio transmission 716 in the computing device 704 may respond by transmitting the audio transmission 710. In certain implementations, the computing device 704 may be configured to regularly transmit an audio transmission 716 that includes a unique identifier 718. In response, the computing device 702 may generate and transmit the audio transmission 710 including the unique identifier 712, which may indicate that the computing device 702 is located near the computing device 704. The unique identifier 718 may be a unique identifier of the facility and/or may be a unique identifier of the computing device 704. Additionally or alternatively, the unique identifier 718 may differ based on a location of the computing device 704 within the facility. For example, where the facility includes multiple computing devices, computing devices 704 located near entrances or exits may utilize a unique identifier that differs from the unique identifier utilized by computing devices located within the facility.

Furthermore, the unique identifier 712 may be a persistent identifier of the user (e.g., may be derived from a name, username, financial information, or other identifiable information for the user). Additionally or alternatively, the unique identifier 712 may be generated for temporary use associated with the user (e.g., while the user is located within the facility). For example, computing device 702 may generate the unique identifier 712 based on the unique identifier 718 received from the computing device 704. In particular, the computing device 702 may generate the unique identifier 712 based on the unique identifier 718 and a private key associated with the user and/or the computing device 702 (e.g., by hashing the unique identifier 718 and the private key). Responses containing the unique identifier 712 may be used to determine the location of the user of the computing device 702 within the facility. For example, the computing device 704 may have a known location within the facility, which may be assigned or otherwise associated with the user (e.g., the unique identifier 712). In certain implementations, the audio transmission 710 may be received by multiple computing devices 704 within the facility. In such instances, the location of the user may be determined as the location of the computing device 704 with the strongest signal strength for the audio transmission 710 and/or as the location of the computing device 704 located closest to the most recent location of the user.

The audio transmission 710 may also include a payment confirmation ID 714. For example, in certain instances, the user may pay using the computing device 702 (e.g., using a mobile payment platform such as Apple Pay®, Google Pay®, Samsung Pay®), may pay using an application executing on the computing device 702 (e.g., an application associated with the facility), and/or may pay using audio transmissions. In such instances, the computing device 702 may receive a payment confirmation ID 714 upon completing the payment. In further instances, the user may use a point-of-sale (POS) device to process payment (e.g., using a credit card or debit card). In such instances, the computing device 702 may receive a payment confirmation ID from the POS device (e.g., via audio transmission). In certain instances, the payment confirmation ID 714 may be encrypted before being added to the audio transmission 710. For example, the payment confirmation ID 714 may be encrypted using a public key associated with the computing device 704 and/or the facility. In one specific example, the unique identifier 718 may be used as a public key to encrypt the payment confirmation ID 714. Additionally or alternatively, a public key associated with a POS or other device used to process payments may be used to encrypt the payment confirmation ID 714. The payment confirmation ID 714 may be decrypted using one or more symmetric or asymmetric encryption protocols. For example, the payment confirmation ID 714 may be encrypted using one or more of Rivest-Shamir-Adleman (RSA) encryption techniques, secure hash algorithm (SHA) encryption techniques, advanced encryption standard (AES) encryption techniques, Triple Data Encryption Standard (DES) encryption techniques, and the like.

The payment confirmation ID 714 may be used to determine whether the user has completed a payment (e.g., for goods purchased from the facility) and is therefore permitted to exit the facility. For example, where the computing device 704 is located at an exit of the facility, the computing device 704 may be configured to confirm whether the user has paid. In certain implementations, the computing device 704 may be used to automatically confirm payments for users exiting the facility. For example, the computing device 704 may be positioned near a turnstile or other physical obstructions of the exit and may permit the user to exit the facility upon confirming that the user has made a payment. As another example, the computing device 704 may be associated with an employee of the facility who confirms payment at an exit of the facility. In such instances, when the computing device 702 approaches the computing device 704, the computing devices 702, 704 may exchange audio transmissions 710, 716. The computing device 704 may confirm payment using the payment confirmation ID 714 and may display an indication that the user has paid and that the user is permitted to exit the facility. In implementations where the payment confirmation ID 714 is encrypted, the computing device 704 may decrypt the payment confirmation ID 714 prior to determining whether the user has completed payment. For example, the computing device 704 may decrypt the payment confirmation ID 714 using a private key associated with the computing device 704.

The database 708 may store information regarding the facility and users or computing devices located (e.g., currently located or previously located) within the facility. For example, the database 708 may store location information 740 of users and/or computing devices within the facility, payment information 720 for processed and completed payments within the facility, and/or order information 730 for in progress or completed orders from within the facility. Turning to the location information 740, the database 708 may store unique identifiers 712 received from computing devices 702 in association with locations 744, 746, 748. For example, as explained above, the location of a computing device 702 may be determined as the location of a computing device 704 that receives an audio transmission 710 from the computing device 702. As audio transmissions containing the unique identifier 712 are received by various computing devices within the facility, the receiving computing devices may update the location information 740 with respective locations of the receiving computing devices (e.g., by storing the locations in association with the unique identifier 712). For example, the computing device 704 may be associated with location 748 within the facility. Upon receiving the audio transmission 710 containing the unique identifier 712, the computing device 704 may add a record to the location information 740 of the database 708 including the unique identifier 712, the location 748, and a time at which the audio transmission 710 was received.

Turning to the payment information 720, the database 708 may store information regarding completed payments 722, 724. For example, the payment information 720 may include information regarding completed payments 722, 724 processed via computing device and/or via POS devices within the facility. In particular, the completed payments 722, 724 may include information regarding payment methods (e.g., computing device, POS device, credit card, debit card, cryptocurrency, and the like), a total amount paid, invoice information, information regarding purchase products, and the like. In certain implementations, the completed payments 722, 724 may additionally include information regarding the user who completed the payment, such as the unique identifier 716. The completed payments 722, 724 may be identified using payment confirmation IDs 714, 728. For example, payment confirmation IDs 714, 728 may be generated for completed payments 722, 724 may be transmitted to computing devices 702 associated with the completed payments 722, 724 and may be used to confirm payments by users prior to the users exiting the facility. In such examples, to confirm payment by users, computing devices 704 located near exits of the facility may compare payment confirmation IDs 714 received via audio transmission 710 to the payment confirmation IDs 714, 728 within the payment information 720. If a corresponding payment confirmation ID 714 is identified within the payment information as corresponding to a completed payment 722, the computing device 704 may determine that the user corresponding to the computing device 702 has completed a payment and is permitted to exit the facility.

Turning to the order information 730, the database 708 may store information regarding in progress or completed orders within the facility. For example, order information 730 may be used in stores that monitor users' location and products intended for purchase. As a specific example, computing devices may be used to detect when new users enter a facility (e.g., a store). Locations and actions of the users may be monitored as the users proceed through the store. For example, computer vision techniques may be used to identify which products a user has placed in their shopping cart or shopping basket (i.e., “products intended for purchase”). The order information 730 may include tracked order information 732, 734 and current statuses 736, 738 for orders. For example, the tracked order information 732, 734 may include a user identifier for a user associated with the order, along with products intended for purchase by the user. The current status 736, 738 may indicate whether the corresponding orders are, e.g., in progress, complete, or canceled.

The tracked order information 732, 734 may continue to be monitored and updated as users add or remove products intended for purchase. Upon detecting that a user has exited the facility or intends to exit the facility, payments may be processed for the order. For example, the user identifier 712 associated with tracked orders may have one or more preferred payment methods that may be used to process payments upon exiting the facility. When payment processing is complete, a current status 736, 738 of the tracked order information 732, 734 may be updated to “complete” and a completed payment may be added to the payment information 720, along with an associated payment confirmation ID. In certain instances, a user may be detected by approaching a computing device 704 positioned near an exit of the facility. For example, computing devices 704 located near exits of the facility may transmit a different unique identifier 718, as discussed above. Upon detecting the unique identifier associated with an exit of the facility, the computing device 702 may proceed with processing payment. Additionally or alternatively, computing devices 704 located near exits of the facility may cause payment to be processed upon receiving an audio transmission 710 containing a unique identifier 712. For example, upon receiving the audio transmission 710, the computing device 704 may cause payment to be processed for a tracked order within the order information 730 that is associated with the unique identifier 712 (e.g., an order with tracked order information 732, 734 containing the unique identifier 712 and having a current status 736, 738 of “in progress”). Additionally or alternatively, it may be determined that a user has exited the facility when an audio transmission is not received from the computing device 702 (e.g., containing the unique identifier 712) for a predetermined period of time, or when the computing device 702 does not receive an audio transmission from a computing device associated with the facility. For example, where computing devices 704 are distributed throughout the facility, the computing device 702 may routinely receive audio transmissions from the computing devices 704 and may routinely transmit audio transmissions 710 to the computing devices 704 containing the unique identifier 712. Accordingly, the failure to receive an audio transmission containing the unique identifier 712 for a predetermined period of time (e.g., one minute, two minutes, five minutes, 10 minutes) may indicate that the user and the computing device 702 have exited the facility. Upon determining that an audio transmission containing the unique identifier 712 has not been received for the predetermined period of time, payment may be processed for orders associated with the unique identifier 712 (e.g., for orders with tracked order information 732, 734 containing the unique identifier 712 and having a current status 736, 738 of “in progress”).

It should be appreciated that one or more of the location information 740, the payment information 720, and the order information 730 may be implemented as separate databases and/or may be implemented as more than one database. For example, the location information 740 may be stored in a local database associated with the facility (e.g., connected to a local network of the facility) and one or both of the payment information 720 and the order information 730 may be implemented as centralized databases (e.g., databases shared among multiple, affiliated facilities) and may be connected to a global network such as the Internet.

The computing device 704 and the database 708 are connected to the network 706, which may be used for communications between the computing device 704 and the database 708. The computing device 704 in the database 708 may connect to the network 706 using one or more wired (e.g., Ethernet) and/or wireless (e.g., Wi-Fi) network interfaces. In certain implementations, the network 706 may be implemented as a local network (e.g., a local network within the facility or a subset of the facility) and/or as a global network (e.g., the Internet).

Furthermore, it should be appreciated that one or more of the above-discussed operations may be optional. For example, in certain implementations order information 730 may not be tracked. Instead, payment information 720 may be used to confirm whether users have paid prior to exiting the facility. Additionally or alternatively, audio transmission 710 from the computing device 702 may not include payment confirmation IDs 714 in certain implementations. For example, where payment is processed after automatically detecting that a user has exited the facility, payment confirmation IDs 714 may not be necessary (i.e., because the user will not have paid prior to exiting the facility). In still further implementations, both payment information 720 and/or order information 730 may be omitted. For example, the system 700 may be configured to monitor locations of users (e.g., employees) within the facility. In such implementations, payment information 720 and/or order information 730 may not be necessary.

One or more of the computing devices 702, 704 and the database 708 may be implemented as one or more computing systems. For example, although not depicted, the computing devices 702, 704 and/or the database 708 may include one or more processors and/or memories configured to implement operational features of the computing devices 702, 704 and/or the database 708. For example, the memories may store instructions which, when executed by the processors, may cause the processors to implement operational features of the computing devices 702, 704 and/or the database 708.

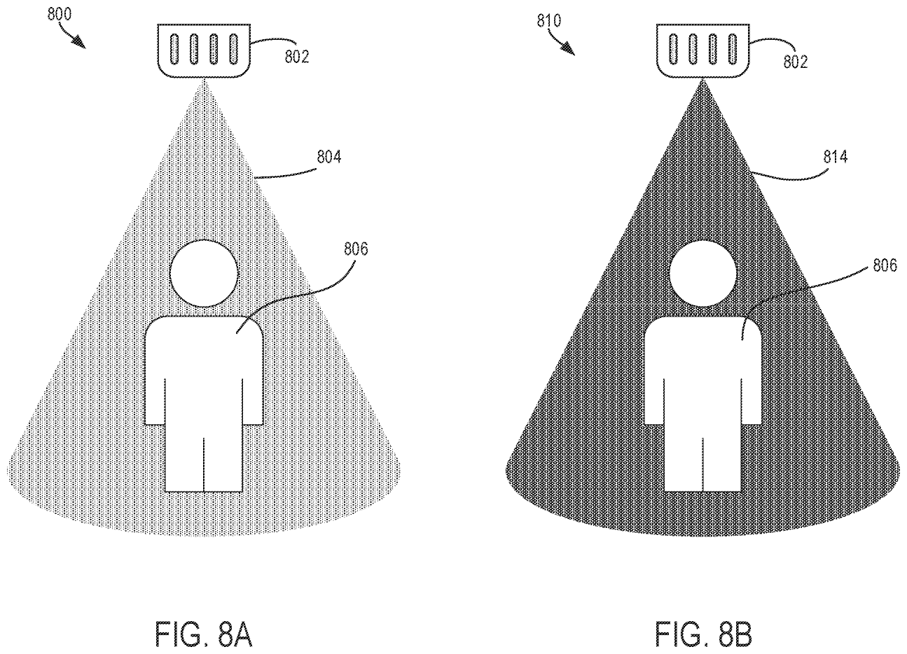

FIGS. 8A-8B illustrate payment confirmation scenarios 800, 810 according to exemplary embodiments of the present disclosure. One or more visual indicators may be used to identify when it is determined that a user is permitted to exit the facility. For example, visual indicators may be used to identify when the computing device 704 determines that a payment confirmation ID 714 received from a computing device 702 corresponds to a completed payment 722. In certain instances, the visual indicators may include light indicators (e.g., lights that turn on or off, lights that change colors). The payment confirmation scenarios 800, 810 illustrate one such implementation. In the payment confirmation scenario 800, a user 806 is standing under a lighting device 802. The lighting device 802 may be communicatively coupled to a computing device 704 and/or may include a computing device 704. The lighting device 802 emits light with a first color 804. The first color 804 may be used to indicate where a user 806 may stand in order to confirm payment. For example, the light may be broadcast to cover an effective range (e.g., a range of 5 feet, 10 feet) for a computing device 704 included within or communicatively coupled to the lighting device 802. In one such instance, the first color 804 may be blue, although other implementations are possible. When the user 806 stands under the lighting device 802, the corresponding computing device 704 and a computing device 702 associated with the user 806 may exchange audio transmissions 710, 716 to confirm payment, as described above. Upon confirming payment, the color of the light emitted by the lighting device 802 may change. For example, in the payment confirmation scenario 810, the light emitted by the lighting device 802 changes to a second color 814. The second color 814 may indicate that the computing device 704 has determined that the user 806 has completed payment and is permitted to exit the facility. In certain implementations, the second color 814 may be green, although other implementations are possible. If the computing device 704 determines that the user 806 has not completed payment, a third color may be displayed (not depicted). For example, the third color may be red, although other implementations are possible.

In certain implementations, the lighting device 802 may not generate light prior to confirming or failing to confirm a payment. For example, in alternative implementations, in the payment confirmation scenario 800, the lighting device 802 may not emit light. In such instances, an effective area of the computing device 704 may be indicated by physical markings, such as carpeting placed on the floor, signage placed within the facility, and/or decals or other visual identifiers placed on the floor. In such instances, the lighting device 802 may illuminate a light (e.g., in the second color 814 or in the third color) after receiving an audio transmission 710 from a computing device 702 associated with the user 806.

It should be appreciated that additional or alternative implementations of the visual indicator are contemplated. For example, rather than being emitted from a lighting device located on a ceiling of the facility, a light may be placed above and exit of the facility and may turn on or off and/or may change colors depending on the results of the above-discussed payment confirmation operations. Additionally or alternatively, the visual indicator may be displayed on a computing device associated with the facility (e.g., associated with an employee of the facility). For example, the visual indicator may be displayed on a computing device monitored by security staff associated with the facility. Additionally or alternatively, employees may be located near exits of the facility to confirm payment by users prior to exiting the facility. For example, the employees may hold or otherwise view the computing device 704 responsible for confirming payment by the users. In such instances, the visual indicator may be displayed on a display of the computing device 704. In one specific example, an employee may hold a smartphone use the smartphone as the computing device 704 to confirm payments by users as the users exit the facility. The employee may monitor a display of the smartphone, which may display the visual indicator of whether a payment was confirmed for the user. In still further implementations, upon determining that the user is permitted to exit, a physical obstruction of the exit (e.g., a door, a turnstile) may be moved (e.g., may open to permit exiting).

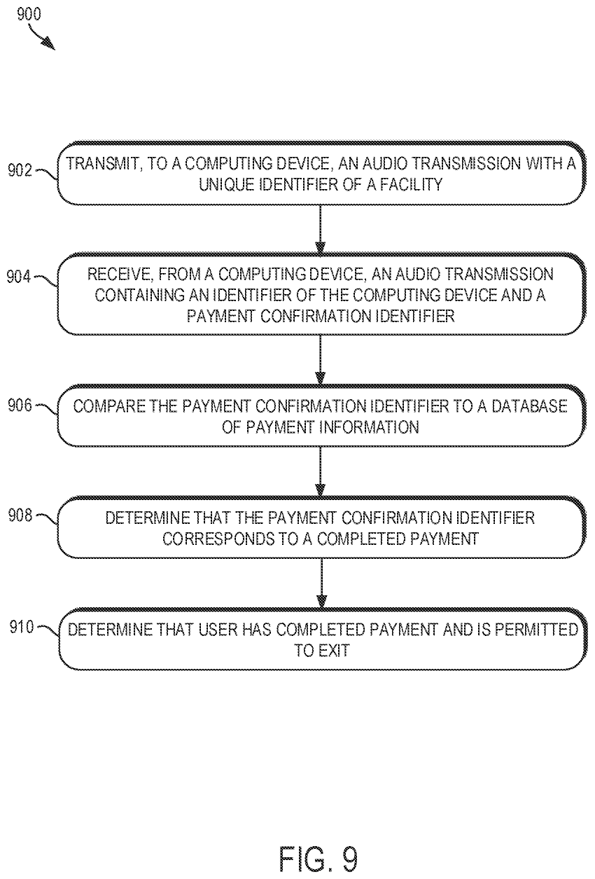

FIG. 9 illustrates a method 900 for exit detection and payment confirmation according to an exemplary embodiment of the present disclosure. The method 900 may be performed to confirm payments by a user prior to exiting a facility. For example, the method 900 been performed to automatically confirm whether users exiting a facility have completed payment at the facility prior to exiting. The method 900 may be implemented by a computer system, such as the systems 600, 700. For example, the method 900 may be performed by the computing device 704 and/or the database 708. The method 900 may be implemented by a set of instructions stored on a computer-readable medium that, when executed by a processor, cause the computer system to perform the method 900. For example, all or part of the method 900 may be implemented by a processor and/or a memory of the computing device 704 and/or the database 708. Although the examples below are described with reference to the flowchart illustrated in FIG. 9, many other methods of performing the acts associated with FIG. 9 may be used. For example, the order of some of the blocks may be changed, certain blocks may be combined with other blocks, one or more of the blocks may be repeated, and some of the blocks described may be optional.

The method 900 begins with transmitting an audio transmission with a unique identifier of a facility (block 902). For example, a computing device 704 may transmit an audio transmission 716 containing a unique identifier 718. The unique identifier 718 may identify the facility, the computing device 704 within the facility, a particular area or location within the facility (e.g., an exit of the facility), and the like. The audio transmission 716 may be transmitted to one or more computing devices 702. For example, the audio transmission 716 may be broadcast within a service area of the computing device 704 (e.g., an effective range of one or more audio transmitters of the computing device 704). One or more computing devices 702 may be located within the service area of the computing device 704 and may receive the audio transmission 716.

An audio transmission may be received from a computing device that contains an identifier of the computing device and a payment confirmation identifier (block 904). For example, the computing device 704 may receive an audio transmission 710 from a computing device 702. In certain instances, the computing device 702 may transmit the audio transmission 710 in response to receiving the audio transmission 716. The audio transmission 710 may contain a unique identifier 712, which may be associated with the computing device 702 and/or a user associated with the computing device 702. As described above, in certain instances, the unique identifier 712 may be generated to identify the computing device 702 for a predetermined period of time (e.g., while the computing device 702 is located within the facility). Additionally or alternatively, the unique identifier 712 may be used to identify the computing device 702 or a user thereof over a longer period of time. The audio transmission 710 may also include a payment confirmation ID 714. As explained above, the computing device 702 may receive the payment confirmation ID 714 after completing payment for a purchase or order within the facility. For example, the computing device 702 may receive the payment confirmation ID 714 after completing payment via an application executing on the computing device 702 or from a POS device used to complete payment. It should be understood that, in certain implementations, one or both of the unique identifier 712 and the payment confirmation ID 714 may be omitted from the audio transmission 710, as explained above. In certain implementations, the audio transmission 716 transmitted by the computing device 704 may be transmitted on a different channel than the audio transmission 710 received from the computing device 702. For example, one or more audio channels (e.g., as discussed above in connection with FIG. 4) may be reserved for communication by computing devices 704 associated with the facility and the remaining audio channels may be used by other computing devices 702 to transmit audio transmissions 710.

The payment confirmation identifier may be compared to a database of payment information (block 906). For example, the computing device 704 may compare the payment confirmation ID 714 received via the audio transmission 710 to information stored within the database 708. In particular, the computing device 704 may compare the payment confirmation ID 714 to payment information 720 stored within the database 708. For example, the computing device 704 may identify a matching payment confirmation ID 714 within the payment information 720. It may be determined that the payment confirmation identifier corresponds to a completed payment (block 908). For example, the computing device 704 may determine that the matching payment confirmation ID 714 within the payment information 720 corresponds to a completed payment 722. It may then be determined that the user has completed payment and is permitted to exit (block 910). For example, based on determining that the payment confirmation ID 714 corresponds to a completed payment 722 within the database 708, the computing device 704 may determine that the user associated with the computing device 702 has completed payment and is permitted to exit. As explained above, upon determining that the user is permitted to exit, one or more visual indicators may be generated and displayed. For example, the method 900 may be performed under a lighting device 802 and a first color 804 of light emitted by the lighting device 802 may be changed to a second color 814 to indicate that payment has been completed. Additionally or alternatively, visual identifiers may be displayed on the computing device 704 or another computing device associated with the facility.

In additional or alternative implementations, rather than confirming a payment confirmation ID 714, the computing devices 702, 704 may cooperate to process payments. For example, instead of receiving an audio transmission 710 containing a unique identifier 712 of a payment confirmation ID 714 at block 904, the audio transmission 710 may contain a unique identifier 712 of an order (e.g., an order with corresponding tracked order information 732, 734 and the database 708). The computing device 704 may then process payment associated with the order (e.g., instead of performing blocks 906, 908). For example, the audio transmission 710 may contain payment information, the tracked order information 732, 734 may be associated with a preferred payment method, and/or another audio transmission may be received from the computing device 702 containing payment information for completing payment. After successfully processing payment, the computing device 704 may determine that the user has completed payment and is permitted to exit, and may display one or more visual identifiers as discussed above. Additionally or alternatively, the computing device 704 may transmit an audio transmission to the computing device 702 containing a payment confirmation ID associated with the process payment.

In still further implementations, rather than confirming a payment confirmation ID 714, the computing devices 702, 704 may cooperate to confirm one or more secondary purchase verifications. For example, certain purchases (e.g., controlled substances, firearms, alcohol, prescription drugs) may require one or more authorizations before an individual is allowed to complete the purchase. The authorizations may, in certain instances, include age verification, government authorization (e.g., firearm owner ID cards, controlled substance approval), prescriptions, and the like. For such purchases, a purchaser's authorization may be verified by exchanging audio transmissions. As a specific example, when a user is purchasing alcohol, instead of receiving an audio transmission 710 containing a unique identifier 712 of a payment confirmation ID 714 at block 904, the audio transmission 710 may contain a unique identifier 712 associated with an ID (e.g., a driver's license) of the user. The computing device 704 may then validate the unique identifier 712. For example, the unique identifier 712 may be cryptographically signed by a government entity (e.g., with a private key associated with the government identity) that issued the ID and the computing device 704 may validate the unique identifier 712 with a public key associated with the government identity. Upon verifying the unique identifier 712, the computing devices 702, 704 may proceed with confirming payment and/or processing payment as discussed above.

The method 900 may enable the automatic detection of when a computing device approaches the exit of a facility and may automate the confirmation of whether payment has been completed by a user associated with the computing device before exiting. In this way, the method 900 may improve recognition of individuals (e.g., employees and customers) located within a facility by determining when the individuals and associated computing devices exit the facility. Additionally, the method 900 may reduce fraud by ensuring payment to customers prior to leaving. Furthermore, the method 900 enables these benefits without requiring unwieldy or inaccurate identification techniques, such as manually using ID cards or badges to indicate when individuals enter or leave the facility or requiring specialized hardware to monitor individuals' locations as discussed above.

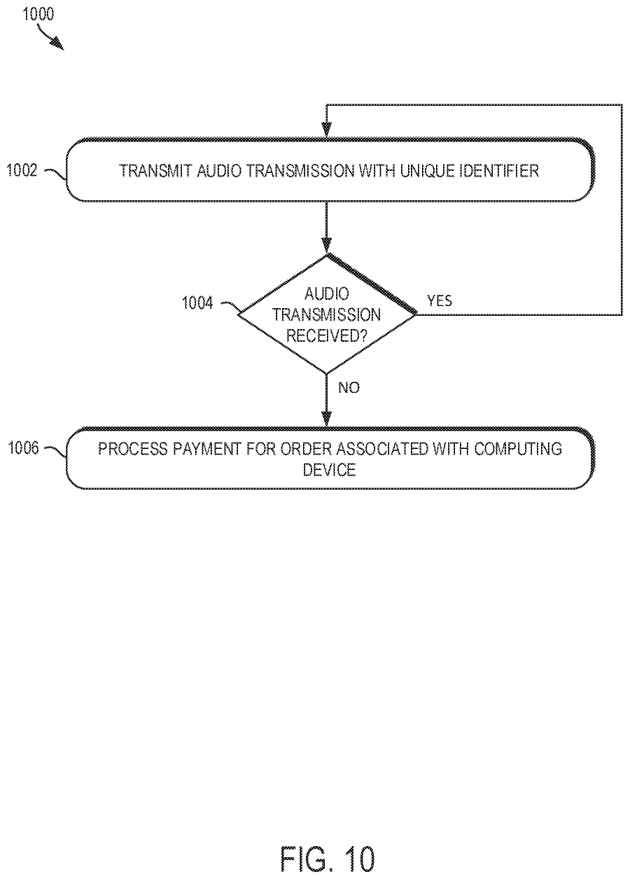

FIG. 10 illustrates a method 1000 for exit detection and payment processing according to an exemplary embodiment of the present disclosure. The method 1000 may be performed to determine when a user exits a facility (e.g., a store or other retail location) and to process payment for orders associated with the user after the user exits. The method 1000 may be implemented by a computer system, such as the systems 600, 700. For example, the method 900 may be performed by the computing device 704 and/or the database 708. The method 1000 may be implemented by a set of instructions stored on a computer-readable medium that, when executed by a processor, cause the computer system to perform the method 1000. For example, all or part of the method 1000 may be implemented by a processor and/or a memory of the computing device 704 and/or the database 708. Although the examples below are described with reference to the flowchart illustrated in FIG. 10, many other methods of performing the acts associated with FIG. 10 may be used. For example, the order of some of the blocks may be changed, certain blocks may be combined with other blocks, one or more of the blocks may be repeated, and some of the blocks described may be optional.

The method 1000 may begin with transmitting an audio transmission with a unique identifier (block 1002). For example, computing devices 704 associated with a facility may transmit an audio transmission 716 containing a unique identifier 718. The unique identifier 718 may identify the facility, particular computing device(s) 704 within the facility, a particular area or location within the facility (e.g., an exit of the facility), and the like. The audio transmission 716 may be transmitted to one or more computing devices 702 located within the facility (e.g., associated with users located within the facility). For example, a particular computing device 704 may transmit an audio transmission 716 within a service area of the computing device 704 (e.g., an effective range of one or more audio transmitters of the computing device 704). One or more computing devices 702 may be located within the service area of the computing device 704 and may receive the audio transmission 716.

It may then be determined whether an audio transmission is received (block 1004). For example, computing devices 702 that receive an audio transmission 716 from the computing device 704 or another computing device located within the facility may be configured to respond with an audio transmission 710 containing a unique identifier 712 of the computing device 702 and/or a user of the computing device 702). If such an audio transmission 710 is received from the computing device 702, it may be determined that the computing device 702 is still located within the facility, and the method 1000 may return to block 1002. In certain instances, upon receiving an audio transmission 710, the computing device 704 that received the audio transmission 710 may update location information 740 within a database 708. For example, the computing device 704 may add an entry to the location information 740 including the unique identifier 712 received with the audio transmission 710 and a location 744, 746, 748 associated with the computing device 704.

If an audio transmission 710 is not received, payment may be processed for an order associated with the computing device (block 1006). For example, if a unique identifier 712 associated with one or more tracked orders within the facility (e.g., a unique identifier 712 contained in tracked order information 732, 734 with a current status 736, 738 of “in progress”) is not received for a predetermined period of time (e.g., one minute, five minutes, 10 minutes), it may be determined that the computing device 702 has exited the facility. In such instances, payment may be processed for the tracked orders. For example, payment may be processed according to one or more preferred payment options (e.g., pre-stored payment information) associated with the unique identifier 712, the computing device 702, and/or a user of the computing device 702.

In certain instances, processing of payments may be omitted. For example, in certain instances the method 1000 may be performed to monitor locations of users within the facility and determine when the users have exited the facility. In such instances, it may not be necessary to process payment associated with orders. Accordingly, at block 1006, it may instead be determined that the computing device 702 and/or a user thereof has exited the facility.

The method 1000 may enable the automatic processing of payments in facilities capable of tracking order information associated with individual users. Additionally or alternatively, the method 1000 may enable the tracking and/or monitoring of user locations within facilities. In either instance, the method 1000 may not require the use of manual techniques (e.g., without requiring users to manually identify themselves when entering or leaving the facility using ID cards, QR code, and the like). Furthermore, the method 1000 may be executed without requiring specialized hardware and without requiring the computing device 702 and the computing device 704 to be on the same network 706 or to otherwise be communicatively paired.

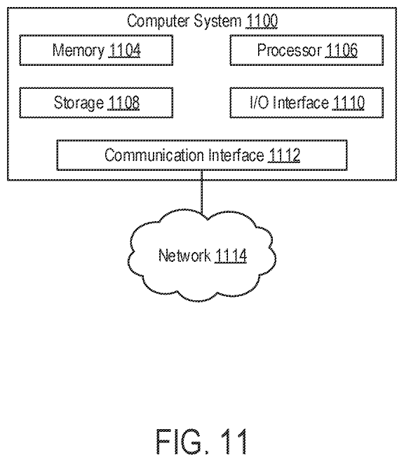

FIG. 11 illustrates an example computer system 1100 that may be utilized to implement one or more of the devices and/or components discussed herein, such as the computing devices 102, 104, 302, 304, 502, 504, 522, 524, 602, 604, 702, 704, the merchant platforms 608A-D, and/or the database 708. In particular embodiments, one or more computer systems 1100 perform one or more steps of one or more methods described or illustrated herein. In particular embodiments, one or more computer systems 1100 provide the functionalities described or illustrated herein. In particular embodiments, software running on one or more computer systems 1100 performs one or more steps of one or more methods described or illustrated herein or provides the functionalities described or illustrated herein. Particular embodiments include one or more portions of one or more computer systems 1100. Herein, a reference to a computer system may encompass a computing device, and vice versa, where appropriate. Moreover, a reference to a computer system may encompass one or more computer systems, where appropriate.

This disclosure contemplates any suitable number of computer systems 1100. This disclosure contemplates the computer system 1100 taking any suitable physical form. As example and not by way of limitation, the computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1106, memory 1104, storage 1108, an input/output (I/O) interface 1110, and a communication interface 1112. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 1106 includes hardware for executing instructions, such as those making up a computer program. As an example and not by way of limitation, to execute instructions, the processor 1106 may retrieve (or fetch) the instructions from an internal register, an internal cache, memory 1104, or storage 1108; decode and execute the instructions; and then write one or more results to an internal register, internal cache, memory 1104, or storage 1108. In particular embodiments, the processor 1106 may include one or more internal caches for data, instructions, or addresses. This disclosure contemplates the processor 1106 including any suitable number of any suitable internal caches, where appropriate. As an example and not by way of limitation, the processor 1106 may include one or more instruction caches, one or more data caches, and one or more translation lookaside buffers (TLBs). Instructions in the instruction caches may be copies of instructions in memory 1104 or storage 1108, and the instruction caches may speed up retrieval of those instructions by the processor 1106. Data in the data caches may be copies of data in memory 1104 or storage 1108 that are to be operated on by computer instructions; the results of previous instructions executed by the processor 1106 that are accessible to subsequent instructions or for writing to memory 1104 or storage 1108; or any other suitable data. The data caches may speed up read or write operations by the processor 1106. The TLBs may speed up virtual-address translation for the processor 1106. In particular embodiments, processor 1106 may include one or more internal registers for data, instructions, or addresses. This disclosure contemplates the processor 1106 including any suitable number of any suitable internal registers, where appropriate. Where appropriate, the processor 1106 may include one or more arithmetic logic units (ALUs), be a multi-core processor, or include one or more processors 1106. Although this disclosure describes and illustrates a particular processor, this disclosure contemplates any suitable processor.

In particular embodiments, the memory 1104 includes main memory for storing instructions for the processor 1106 to execute or data for processor 1106 to operate on. As an example, and not by way of limitation, computer system 1100 may load instructions from storage 1108 or another source (such as another computer system 1100) to the memory 1104. The processor 1106 may then load the instructions from the memory 1104 to an internal register or internal cache. To execute the instructions, the processor 1106 may retrieve the instructions from the internal register or internal cache and decode them. During or after execution of the instructions, the processor 1106 may write one or more results (which may be intermediate or final results) to the internal register or internal cache. The processor 1106 may then write one or more of those results to the memory 1104. In particular embodiments, the processor 1106 executes only instructions in one or more internal registers or internal caches or in memory 1104 (as opposed to storage 1108 or elsewhere) and operates only on data in one or more internal registers or internal caches or in memory 1104 (as opposed to storage 1108 or elsewhere). One or more memory buses (which may each include an address bus and a data bus) may couple the processor 1106 to the memory 1104. The bus may include one or more memory buses, as described in further detail below. In particular embodiments, one or more memory management units (MMUs) reside between the processor 1106 and memory 1104 and facilitate accesses to the memory 1104 requested by the processor 1106. In particular embodiments, the memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory implementations, this disclosure contemplates any suitable memory implementation.

In particular embodiments, the storage 1108 includes mass storage for data or instructions. As an example and not by way of limitation, the storage 1108 may include a hard disk drive (HDD), a floppy disk drive, flash memory, an optical disc, a magneto-optical disc, magnetic tape, or a Universal Serial Bus (USB) drive or a combination of two or more of these. The storage 1108 may include removable or non-removable (or fixed) media, where appropriate. The storage 1108 may be internal or external to computer system 1100, where appropriate. In particular embodiments, the storage 1108 is non-volatile, solid-state memory. In particular embodiments, the storage 1108 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1108 taking any suitable physical form. The storage 1108 may include one or more storage control units facilitating communication between processor 1106 and storage 1108, where appropriate. Where appropriate, the storage 1108 may include one or more storages 1108. Although this disclosure describes and illustrates particular storage, this disclosure contemplates any suitable storage.

In particular embodiments, the I/O Interface 1110 includes hardware, software, or both, providing one or more interfaces for communication between computer system 1100 and one or more I/O devices. The computer system 1100 may include one or more of these I/O devices, where appropriate. One or more of these I/O devices may enable communication between a person (i.e., a user) and computer system 1100. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 1110 may include one or more device or software drivers enabling processor 1106 to drive one or more of these I/O devices. The I/O interface 1110 may include one or more I/O interfaces 1110, where appropriate. Although this disclosure describes and illustrates a particular I/O interface, this disclosure contemplates any suitable I/O interface or combination of I/O interfaces.

In particular embodiments, communication interface 1112 includes hardware, software, or both providing one or more interfaces for communication (such as, for example, packet-based communication) between computer system 1100 and one or more other computer systems 1100 or one or more networks 1114. As an example and not by way of limitation, communication interface 1112 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 1114 and any suitable communication interface 1112 for the network 1114. As an example and not by way of limitation, the network 1114 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a Bluetooth® WPAN), a WI-Fl network, a WI-MAX network, a cellular telephone network (such as, for example, a Global System for Mobile Communications (GSM) network), or any other suitable wireless network or a combination of two or more of these. Computer system 1100 may include any suitable communication interface 1112 for any of these networks, where appropriate. Communication interface 1112 may include one or more communication interfaces 1112, where appropriate. Although this disclosure describes and illustrates a particular communication interface implementations, this disclosure contemplates any suitable communication interface implementation.

The computer system 1102 may also include a bus. The bus may include hardware, software, or both and may communicatively couple the components of the computer system 1100 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
transmitting, to a first computing device, an audio transmission with a first unique identifier of a facility;
receiving, from the first computing device, an audio transmission containing a first identifier of a user associated with the first computing device and a payment confirmation identifier;
comparing the payment confirmation identifier to a database of payment information;
determining that the payment confirmation identifier corresponds to at least one completed payment within the database of payment information; and
determining that the user has completed a payment and is permitted to exit the facility.

2. The method of claim 1, wherein the first unique identifier is transmitted by a transmitter located near an exit of the facility.

3. The method of claim 2, further comprising (i) transmitting, to the first computing device, audio transmissions containing a second unique identifier of the facility.

4. The method of claim 3, further comprising (ii) receiving, from the first computing device an audio transmission containing a second identifier of the user.

5. The method of claim 4, further comprising repeating (i) and (ii) until the second identifier is not received from the first computing device at (ii) and, in response to determining that the second identifier is not received, processing payment for a purchase associated with the user associated with the first computing device.

6. The method of claim 4, further comprising comparing the first identifier to the second identifier to identify the user.

7. The method of claim 3, wherein the second unique identifier of the facility is identical to the first unique identifier of the facility.

8. The method of claim 3, wherein the second unique identifier differs at least in part from the first unique identifier of the facility.

9. The method of claim 1, wherein the first identifier of the user is a persistent identifier of the user.

10. The method of claim 1, further comprising at least one of (i) illuminating a light over the user, (ii) changing the color of a light over the user, (iii) updating a first visual indicator located near an exit of the facility, (iv) removing a physical obstruction of the exit, (v) displaying a second visual indicator on the first computing device, and (vi) displaying a third visual indicator on a second computing device associated with the facility.

11. The method of claim 1, wherein the first computing device at least temporarily lacks an Internet connection.

12. The method of claim 1, wherein the facility is a store.

13. The method of claim 1, wherein the database of payment information is located on a third computing device connected to a local network of the facility.

14. A system comprising:
a processor; and
a memory storing instructions which, when executed by the processor, cause the processor to:
transmit, to a first computing device, an audio transmission with a first unique identifier of a facility;
receive, from the first computing device, an audio transmission containing a first identifier of a user associated with the first computing device and a payment confirmation identifier;
compare the payment confirmation identifier to a database of payment information;
determine that the payment confirmation identifier corresponds to at least one completed payment within the database of payment information; and
determine that the user has completed a payment and is permitted to exit the facility.

15. The system of claim 14, wherein the first unique identifier is transmitted by a transmitter located near an exit of the facility.

16. The system of claim 15, wherein the instructions further cause the processor to (i) transmit, to the first computing device, audio transmissions containing a second unique identifier of the facility.

17. The system of claim 16, wherein the instructions further cause the processor to (ii) receive, from the first computing device an audio transmission containing a second identifier of the user.

18. The system of claim 17, wherein the instructions further cause the processor to repeat (i) and (ii) until the second identifier is not received from the first computing device at (ii) and, in response to determining that the second identifier is not received, process payment for a purchase associated with the user associated with the first computing device.

19. The system of claim 16, wherein the second unique identifier of the facility is identical to the first unique identifier of the facility.

20. The system of claim 16, wherein the second unique identifier differs at least in part from the first unique identifier of the facility.
